(19) United States
(12) Patent Application Publication
(10) Pub. No.: US 2012/0047172 A1
(43) Pub. Date: Feb. 23, 2012

(54) PARALLEL DOCUMENT MINING

(75) Inventors: Jay M. Ponte, Mountain View, CA (US); Jakob Uszkoreit, San Francisco, CA (US); Ashok C. Popat, Menlo Park, CA (US); Moshe Dubiner, Cupertino, CA (US)

(73) Assignee: Google Inc., Mountain View, CA (US)

(21) Appl. No.: 13/214,941

(22) Filed: Aug. 22, 2011

Related U.S. Application Data
(60) Provisional application No. 61/376,082, filed on Aug. 23, 2010.

(51) Int. Cl. G06F 17/30

(52) U.S. Cl. 707/776; 707/E17.022

(57) ABSTRACT

A technique includes providing a collection of documents in multiple languages, identifying, from the collection of documents, a group of candidate documents, where each candidate document in the group shares multiple corresponding rare features, evaluating pairs of candidate documents in the group using multiple common features present in the collection of documents, and determining, based on evaluating the pairs of candidate documents, whether each pair of candidate documents corresponds to a translated pair of documents.

### CROSS-REFERENCE TO RELATED APPLICATIONS

This application claims priority to Provisional Application No. 61/376,082, filed on Aug. 23, 2010, the entire contents of which is incorporated herein by reference.

### BACKGROUND

This disclosure relates to information retrieval. Manual translation of text by a human operator can be time consuming and costly. Machine translation can be used to automatically translate text in a source language to corresponding text in a target language. In some implementations, automated statistical machine translation systems are trained based on parallel aligned data. Parallel data is text or other data in one language together with a translation of the text or data in another language. Alignment of parallel text includes the identification of the corresponding sentences in both languages of the parallel text. The aligned parallel text can be used to train the statistical machine translation systems to identify the most probable translation in a target language given a particular input in a different source language. While the World Wide Web provides an abundance of readily available monolingual text, parallel data is still a comparatively scarce resource.

### SUMMARY

In general, one aspect of the subject matter described in this specification relates to computer-implemented techniques that include providing a collection of documents in multiple languages, identifying, from the collection of documents, a group of candidate documents, where each candidate document in the group shares multiple corresponding rare features having a low frequency of occurrence in the collection of documents, evaluating pairs of candidate documents in the group using multiple common features present in the collection of documents, and determining, based on evaluating the pairs of candidate documents, whether each pair of candidate documents corresponds to a translated pair of documents.

Implementations of the technique include various features. For example, in some implementations, providing the collection of documents in multiple languages includes translating one or more of the documents into a single language.

In some implementations, each rare feature is a feature likely to occur in at least one translated document and at least one other document in the collection of documents. Each common feature can be a feature that is more likely to occur in the collection of documents than any one of the rare features in the collection of documents.

In some implementations, the multiple corresponding rare features include portions of text extracted from the collection of documents.

In some implementations, the multiple corresponding rare features include multiple n-grams.

In some implementations, the multiple common features include portions of text extracted from the collection of documents.

In some implementations, the multiple common features include multiple n-grams.

In some implementations, evaluating the pairs of candidate documents includes scoring each pair of candidate documents based on at least some of the multiple common features to obtain a candidate pair score. Scoring each pair of candidate documents includes calculating a cosine similarity between a first vector representing a first set of common features included in a first candidate document in a pair and a second vector representing a second set of common features included in a second candidate document in the pair. The technique can further include discarding one or more pairs of candidate documents having a candidate pair score below a threshold value to obtain one or more remaining pairs of candidate documents. Determining whether the candidate documents in each pair correspond to a translated pair of documents includes identifying, for a first candidate document in the pair, a first list of different candidate documents corresponding to the first candidate document, based on the one or more remaining pairs of candidate documents. Each of the corresponding candidate documents in the first list can be derived from a same first language. Determining whether the candidate documents in each pair correspond to a translated pair of documents further can include identifying, for a second candidate document in the pair, a second list of different candidate documents corresponding to the second candidate document, based on the one or more remaining pairs of candidate documents and identifying the first candidate document and the second candidate document as a translated pair of documents if the second candidate document is in the first list and if the first candidate document is in the second list.

In some implementations, the translated pair of documents identifies a first document in a first language and a second document in a second language, the second document corresponding to a translation of the first document.

In another aspect, a technique includes extracting, from a collection of documents in multiple languages, multiple matching features and multiple scoring features, generating a forward index based on the multiple scoring features, the forward index including one or more scoring feature lists containing at least one scoring feature extracted from the documents in the collection, generating an inverted index based on the multiple matching features, the inverted index including one or more matching document lists, where each matching document list identifies a group of matching documents from the collection that share a corresponding matching feature, generating, for each matching document list in the inverted index, corresponding matching document pairs, calculating, for each matching document pair, a score based on information from the forward index, and determining, based on the score of each matching document pair, whether each matching document pair contains a first matching document and a second matching document that is a translation of the first matching document.

In some implementations the matching features occur less frequently in the collection of documents than the scoring features.

In some implementations, the technique further includes translating the collection of documents in multiple languages into a collection of documents in a single language.

In some implementations, each one or more scoring feature list is indexed by a different corresponding document in the collection.

In some implementations, each matching document list is indexed by the corresponding matching feature.

In some implementations, calculating the score based on information from the forward index includes calculating a cosine similarity between a first scoring feature list corresponding to a first matching document in the matching document pair and a second scoring feature list corresponding to a second matching document in the matching document pair.

In some implementations, determining whether each matching document pair contains a first matching document and a second matching document that is a translation of the first matching document includes discarding matching document pairs having a score below a threshold value. Determining can further include generating, for each matching document in the group, a corresponding list of likely translation documents based on remaining matching document pairs. Determining can further include identifying, for each matching document pair, whether the second matching document is in a list of likely translation documents corresponding to the first matching document and whether the first matching document is in a list of likely translation documents corresponding to the second matching document.

In another aspect, a parallel document mining tool includes one or more processors and memory, and is configured to interact to perform operations including providing a collection of documents in multiple languages, identifying, from the collection of documents, a group of candidate documents, where each candidate document in the group shares multiple corresponding rare features, evaluating pairs of candidate documents in the group using multiple common features present in the collection of documents, and determining, based on evaluating the pairs of candidate documents, whether each pair of candidate documents corresponds to a translated pair of documents.

In some implementations, providing the collection of documents in multiple languages includes translating the collection of documents in multiple languages into a single language.

In some implementations, each rare feature can be a feature likely to occur in at least one translated document and at least one other document in the collection of documents. Each common feature can be a feature that is more likely to occur in the collection of documents than any one of the rare features in the collection of documents.

The multiple corresponding rare features can include portions of text extracted from the collection of documents. The multiple corresponding rare features can include multiple n-grams. The multiple common features can include portions of text extracted from the collection of documents. The multiple common features include multiple n-grams.

In some implementations, evaluating the pairs of candidate documents includes scoring each pair of candidate documents based on the common features to obtain a candidate pair score. Scoring each pair of candidate documents can include calculating a cosine similarity between a first vector representing a first set of common features included in a first candidate document in a pair and a second vector representing a second set of common features included in a second candidate document in the pair. The tool can be further configured to perform operations including discarding one or more pairs of candidate documents having a candidate pair score below a threshold value to obtain one or more remaining pairs of candidate documents. Determining whether the candidate documents in each pair correspond to a translated pair of documents can include identifying, for a first candidate document in the pair, a first list of different candidate documents corresponding to the first candidate document, based on the one or more remaining pairs of candidate documents. Each of the corresponding candidate documents in the first list can be derived from a same first language. Determining whether the candidate documents in each pair correspond to a translated pair of documents can further include identifying, for a second candidate document in the pair, a second list of different candidate documents corresponding to the second candidate document, based on the one or more remaining pairs of candidate documents, and identifying the first candidate document and the second candidate document as the translated pair of documents if the second candidate document is in the first list and if the first candidate document is in the second list.

In some implementations, the translated pair of documents includes a first document in a first language and a second document in a second language, the second document corresponding to a translation of the first document.

Another aspect of the subject matter described in this specification relates to instructions encoded on a computer-readable medium in which the instructions, when executed, cause a data processing apparatus to perform operations including providing a collection of documents in multiple languages, identifying, from the collection of documents, a group of candidate documents, where each candidate document in the group shares multiple corresponding rare features, evaluating pairs of candidate documents in the group using multiple common features present in the collection of documents, and determining, based on evaluating the pairs of candidate documents, whether each pair of candidate documents corresponds to a translated pair of documents.

In some implementations, providing the collection of documents in multiple languages includes translating one or more of the documents into a single language.

In some implementations, each rare feature is a feature likely to occur in at least one translated document and at least one other document in the collection of documents. Each common feature can be a feature that is more likely to occur in the collection of documents than any one of the rare features in the collection of documents.

In some implementations, the multiple corresponding rare features include portions of text extracted from the collection of documents.

In some implementations, the multiple corresponding rare features include multiple n-grams.

In some implementations, the multiple common features include portions of text extracted from the collection of documents.

In some implementations, the multiple common features include multiple n-grams.

In some implementations, evaluating the pairs of candidate documents includes scoring each pair of candidate documents based on at least some of the multiple common features to obtain a candidate pair score. Scoring each pair of candidate documents can include calculating a cosine similarity between a first vector representing a first set of common features included in a first candidate document in a pair and a second vector representing a second set of common features included in a second candidate document in the pair. The instructions, when executed, can cause the data processing apparatus to perform operations further including discarding one or more pairs of candidate documents having a candidate pair score below a threshold value to obtain one or more remaining pairs of candidate documents. Determining whether the candidate documents in each pair correspond to a translated pair of documents can include identifying, for a first candidate document in the pair, a first list of different candidate documents corresponding to the first candidate document, based on the one or more remaining pairs of candidate documents. Each of the corresponding candidate documents in the first list can be derived from a same first language. Determining whether the candidate documents in each pair correspond to a translated pair of documents can further include identifying, for a second candidate document in the pair, a second list of different candidate documents corresponding to the second candidate document, based on the one or more remaining pairs of candidate documents, and identifying the first candidate document and the second candidate document as a translated pair of documents if the second candidate document is in the first list and if the first candidate document is in the second list.

In some implementations, the translated pair of documents identifies a first document in a first language and a second document in a second language, the second document corresponding to a translation of the first document.

Particular embodiments of the subject matter described in this specification can be implemented to realize none, one or more of the following advantages. Mining parallel text can be achieved utilizing heterogeneous corpora and without the need for metadata. The data mining can be implemented in a highly parallel manner, thus reducing the required level of system resources. The overall runtime of a system performing the data mining operations can be linear in size with the input data. Furthermore, the system can scale so as to operate on very large document collections. Other advantages will be apparent from the description, drawings, and from the claims.

### BRIEF DESCRIPTION OF DRAWINGS

FIG. 1 is a block diagram of an example parallel document mining tool.

FIG. 2 is a flowchart of an example technique for mining parallel documents.

FIG. 3 is a flowchart of an example technique for mining parallel documents.

FIG. 4 is an example diagram of an example computer apparatus.

### DETAILED DESCRIPTION

In general, one aspect of the subject matter described in this specification relates to computer-implemented techniques of document mining for machine translation. The techniques disclosed can include, for example, providing a collection of documents in a single language, in which one or more of the documents have been translated from a different language. A group of candidate translation documents, i.e., documents corresponding to potential translations of one another, are identified in the collection based on one or more rare features that those candidate translation documents share. From the group of candidate translation documents, pairs of documents are specified as translations based on more common features that each individual document in the pair shares. The identification of translated documents then can be used in various applications including, for example, as training data for machine translation tools.

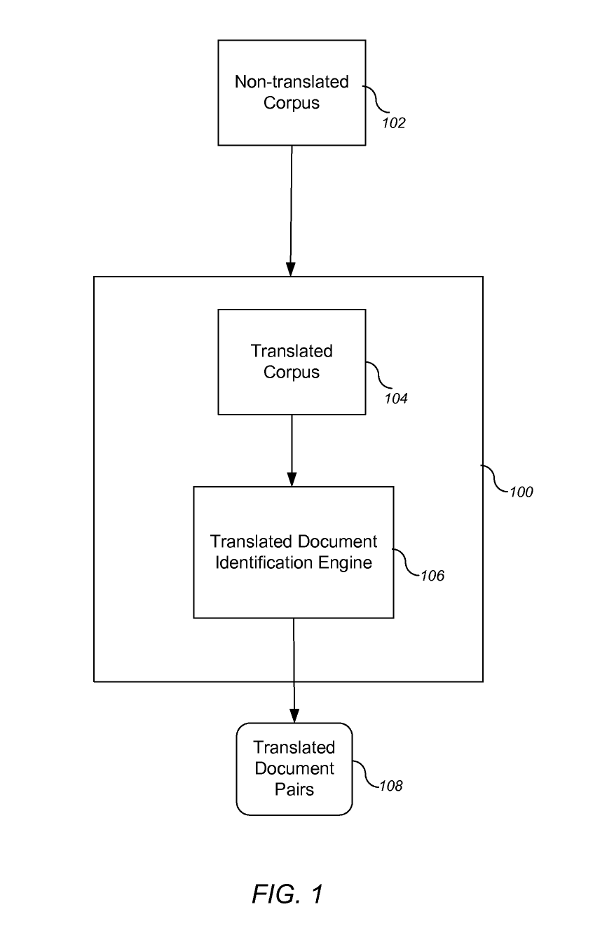

FIG. 1 is a block diagram of an example parallel document mining tool 100. Parallel document mining tool 100 includes a translated corpus 104 and a translated document identification engine 106. The translated corpus 104 includes a collection of documents in a single target language (e.g., English), in which one or more of the documents in the corpus 104 has been previously translated from a different language. For example, in some implementations, the collection of translated documents in the translated corpus 104 is obtained from a non-translated corpus 102. The non-translated corpus 102 contains a collection of documents in the target language and a corresponding translation for one or more of the documents in at least one different source language. To generate the translated corpus 104, any documents from corpus 102 that are in a language different from the target language are translated into the target language. Accordingly, the collection of translated documents and the documents originally in the target language establish the translated corpus 104.

The translated document identification engine 106 identifies pairs of documents from the translated corpus 104 or from the non-translated corpus that are likely to correspond to a translation of one another. That is, for a first document in the translated corpus 104 (or non-translated corpus 102), the translated document identification engine 106 identifies one or more second documents in the translated corpus 104 (or non-translated corpus 102) that correspond to a translated version of the first document. Based on the identification, the translated document identification engine 106 can output from the tool 100 one or more translated document pairs 108, each of which includes a document in the target language and a corresponding second document identified as the corresponding version of the first document in a different language.

The non-translated corpus 102 can include a number of different document sources, including, for example, web pages, blog posts, digitized books, and news article pairs, among others, where each pair includes text in the target language and the corresponding text in a different language. In some implementations, the non-translated corpus 102 includes text on the order of tens to hundreds of billions of words, or even more. Examples of non-translated corpora include the Europarl Corpus, the Directorate-General for Translation (DGT) Multilingual Translation Memory, and the United Nations Official Document System (ODS) corpus. In contrast, each pair in the translated corpus 104 includes text in the target language and the corresponding translated text obtained from translating a corresponding different language document.

In general, the document pairs in the non-translated corpus 102 are not tagged or identified to indicate that a first document in a pair corresponds to a translated version of the second document in the pair. Similarly, document pairs in the translated corpus 104 generally are not tagged or identified to indicate corresponding parallel text. The documents in the corpora can be text or text with other content (e.g., images, video, audio, or other data). Additionally, in some implementations, a document does not necessarily correspond to a file. A document may be stored in a portion of a file that holds other documents, in a single file dedicated to the document in question, or in multiple coordinated files. Although shown separately in FIG. 1, the non-translated corpus 102 can, in some implementations, be included as part of the tool 100.

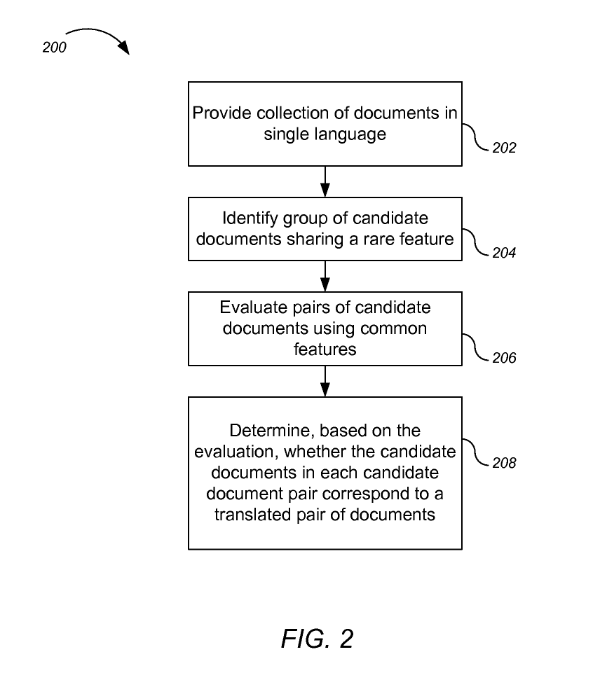

FIG. 2 is a flowchart of an example technique 200 for mining parallel documents. The technique can be used in tools such as, for example, the document mining tool 100 of FIG. 1. In stage 202, a collection of documents in a single target language is optionally provided. As explained above in reference to FIG. 1, the documents can be from one or more sources including, for example, news articles, blog posts, and websites. For example, in some implementations, a collection of documents in multiple different source languages (e.g., French, Chinese, Russian, English, etc.) are translated to provide the collection of documents in the target language (e.g., English). The translations can be performed by a tool using, for example, an automated machine translation device. Alternatively, or in addition, the translations can be performed manually by a human. In some cases, a collection of documents previously translated into the target language is available in a database, such that translation of the documents is not necessary.

In stage 204, a group of candidate documents from the collection of documents in the single target language is identified. Alternatively, a group of candidate documents is identified from a collection of documents in multiple languages, if the collection has not been provided in a single language. In some implementations, the collection of documents is filtered to identify documents which are potential translations of one another. Each of the candidate documents in the group shares one or more features having a low frequency of occurrence among the entire collection of documents in the single target language, i.e., the candidate documents each share one or more features considered to be “rare” overall among the entire collection of documents in the single target language. The low frequency occurrence features can include any document feature that a user considers likely to be substantially unique to a pair of documents that are translations of one another and thus unlikely in a document that does not have a corresponding translation. In general, a rare feature includes a feature that occurs in several percent or less of the total number of documents in the collection. For example, a low frequency occurrence feature can include a document feature that occurs in less than 5%, less than 1%, less than 0.1%, less than 0.01%, less than 0.001%, less than 0.0001%, less than 0.00001%, or less than 0.000001% of the documents in the collection, although other suitable low frequency occurrence rates may be used as well.

The features can include, but are not limited to, a particular arrangement of tokens, where a token can be a character, number, letter, punctuation, word, phrase, sentence, or any other lexical unit from the document or combination thereof. In some cases, the features can include portions of a word, phrase, sentence, or paragraph contained within the document, or any combination thereof. In some implementations, the features are represented using n-grams. An n-gram includes a sequence of n consecutive or non-consecutive tokens. For example, a 1-gram (or unigram) includes one token; a 2-gram (or bigram) includes two consecutive tokens. Alternatively, or in addition, the tokens are not arranged consecutively. For example, in some implementations, the tokens may be arranged in non-consecutive locations in a document. In some implementations, the candidate documents are identified by first extracting the desired “rare” features from the collection of documents in the single target language and then locating the documents in the collection which contain the extracted rare features. The features may be taken from any portion of the document including, for example, a uniform resource locator (URL) or hyperlink associated with a document or from other text in the documents, such as translated text.

In stage 206, pairs of the identified candidate documents are evaluated using features that are generally more common than the rare features. That is, the identified candidate documents are arranged into pairs and the documents within each pair are compared to one another based on features that have a frequency of occurrence among the entire collection of documents that is higher than a frequency of occurrence for the rare features. In some implementations, the evaluation can include scoring the candidate document pairs based on how many common features each document in the pair shares. Candidate document pairs sharing relatively many common features will have higher scores than the candidate document pairs sharing relatively fewer common features. In some implementations, the score can be based simply on the total number of common features shared and/or based on the frequency of the shared common features among the collection. Other information also may be used in evaluating the relationship between candidate documents in a candidate document pair. As with the rare features, common features can include, but are not limited to, a particular arrangement of tokens, where a token can be a character, number, letter, punctuation, word, phrase, sentence, or any other lexical unit or combination thereof contained within a document. Alternatively, or in addition, the common features can include any portion of a word, phrase, sentence, or paragraph contained within a document, or any combination thereof. A common feature can include an n-gram containing consecutively arranged tokens or non-consecutively arranged tokens.

Based on the evaluation in stage 206, a determination is made in stage 208 as to whether the candidate documents in each candidate document pair correspond to a translated pair of documents. The determination can be made using one or more factors obtained from stage 206. For example, in some implementations, the determination can be made based on a number of common features shared by the candidate document pairs in which the number of the shared features can be represented using a score. In the example, candidate document pairs identified as having a score above a specified threshold are retained, whereas candidate document pairs identified in stage 206 as having a score below the specified threshold are discarded. Each of the retained candidate document pairs then may be identified as corresponding to a translation pair, i.e., a document and its corresponding translation. In some implementations, the determination may be performed for each candidate document and for each source language.

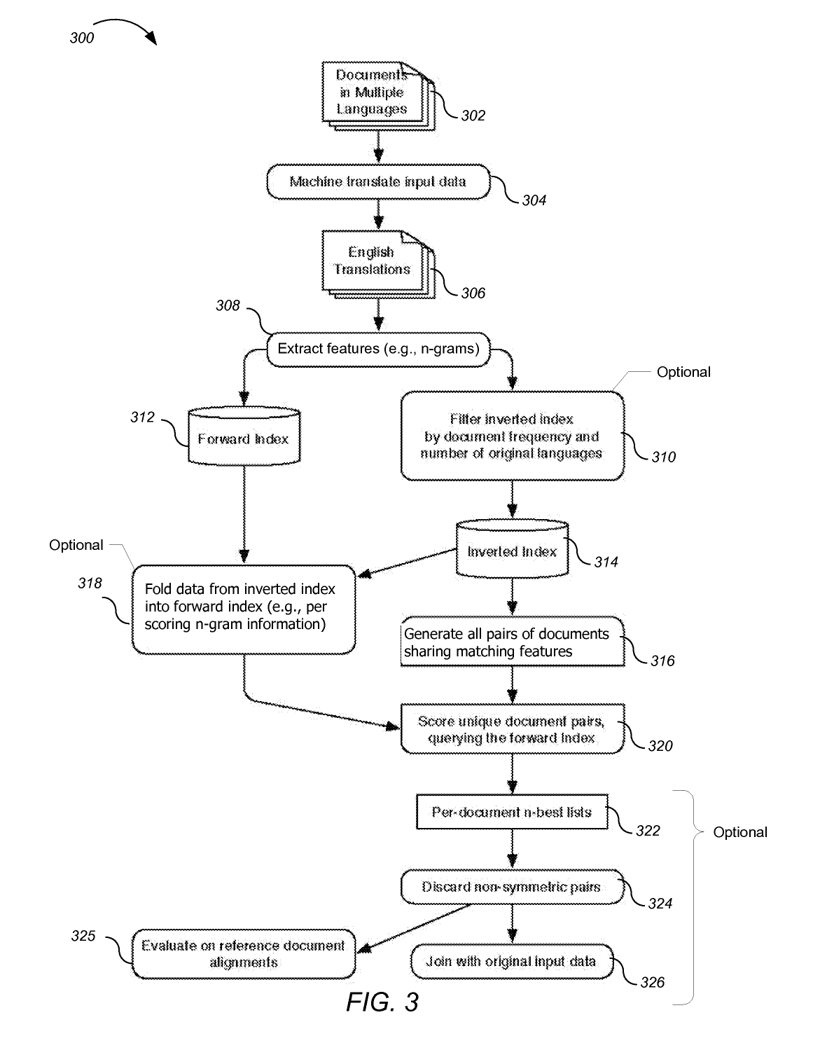

FIG. 3 is a flowchart of another example technique for mining parallel documents. The technique described with respect to FIG. 3 can be executed by tools such as, for example, the document mining tool 100 of FIG. 1.

In stage 304, a collection of documents 302 in multiple languages is provided as input data to a machine translation tool. The input data can include a set of documents from diverse sources such as web pages, digitized books, news articles, blog posts, among others. In some implementations, the documents can be independently translated using, for example, a baseline statistical machine translation tool to provide a collection of documents in a target language 306. For example, to translate the collection of documents into English, a phrase-based statistical machine translation tools based on the log-linear formulation of the problem can be used. An example of the foregoing tool can be found in “Discriminative training and maximum entropy models for statistical machine translation” (Och and Ney, In Proceedings of the 40th Annual Meeting of the Association for Computational Linguistics (ACL), pp. 295-302, Philadelphia, Pa., USA 2002). The target language for which translation is performed is not restricted to English and can instead include other languages.

In stage 308, two different sets of features then are extracted from the collection of documents in the target language: rare features which have a low frequency of occurrence in the translated collection of documents and common features which have a higher frequency of occurrence in the translated collection of documents. In some implementations, the rare features and common features are represented using n-grams, where rare n-grams are referred to as “scoring” n-grams and more common n-grams are referred to as “matching” n-grams. As explained above with respect to FIG. 2, an n-gram includes a sequence of n consecutive tokens, where n indicates the order. In general, n-grams having higher orders tend to occur less frequently than n-grams with lower orders. That is, the probability of a particular sequence of letters, words, characters, etc., occurring in a collection of documents generally decreases with an increase in the length of the sequence. Accordingly, for the purpose of identifying candidate documents that are potential translations of one another, a matching n-gram typically will have a higher order than a scoring n-gram. The order of the scoring n-grams and the matching n-grams can be selected to be any whole integer positive number. For example, the order of the scoring n-grams can include, but is not limited to n=1, 2, 3, 4 or 5. Similarly, the order of the matching n-grams can include, but is not limited to n=2, 3, 4, 5 or 6.

Based on the features (e.g., n-grams) extracted from the collection of documents in the target language, two separate indexes are generated: a forward index 312 (e.g., listing all of the extracted scoring n-grams, where each scoring n-gram is indexed by the document(s) in which scoring n-gram occurs in the collection of translated documents); and an inverted index 314 (e.g., listing all documents from which each matching n-gram was extracted, where the documents in the inverted index 314 are indexed by the matching n-grams extracted from those documents).

Optionally, in stage 310, generating the inverted index 314 can include filtering the index by document frequency and/or number of source languages from which the translated documents were obtained. For example, in some implementations, the number of candidate documents which contain a particular matching n-gram can be rather large, i.e., the frequency in which the matching n-gram occurs is high. Thus, the inverted index can be further refined by filtering out references to candidate documents that contain a matching n-gram having a frequency of occurrence in the collection of documents above a specified threshold. By filtering the inverted index using the occurrence frequency of the matching n-grams, a tool performing the technique 300 can exhibit, in some implementations, a runtime that is linear with the size of the input data, such that the tool can be scaled for use with very large document collections.

Alternatively, or in addition, listings in the index which contain a single document can be discarded. In some implementations, the foregoing “singleton” n-grams are representative of documents that are available in just one language in the collection and thus are not useful for identifying pairs of documents which are translations of one another.

In stage 316, all possible pairs of candidate documents within the inverted index are generated. In some implementations, each candidate document in a pair corresponds to a different original language. That is, if a first candidate document listed in a pair is in the target language and has not been translated, then a second document listed in the pair corresponds to a document that has been translated from a language that is different than the target language. Alternatively, if the first document listed in the pair has been translated from a first source language that is different from the target language, the second document listed in the pair can be either a document in the target language that has not been translated or a document that has been translated from a second source language that is different from the first source language. In some implementations, candidate pairs that include documents corresponding to the same language (i.e., documents that have been translated from the same source language or non-translated documents in the target language) are discarded. In some implementations, the original language of a document (prior to translation into the target language) may be stored in metadata of the document and/or may be inferred automatically using one or more automatic language detection tools.

In some implementations, candidate pairs can be created from all documents that include a sufficient number of rare features. For example, where three documents contain a sufficient number of rare features, 6 pairs of candidate documents can be created from the three (candidate documents A, B and C can produce the following pairs of candidate documents are generated: AB, AC, BA, BC, CA and CB).

Optionally, in stage 318, information about the features that are common to the candidate documents (e.g., scoring n-grams) can be folded/copied from the inverted index into the forward index. For example, information pertaining to the entire input collection of documents (i.e., “global” information), such as the scoring n-gram document frequency (i.e., the absolute number of occurrences of the scoring n-gram over the input collection) can be added to the forward index. That is to say, for a given feature (e.g., the 5-gram, “I am going home now”), the inverted index contains all the documents in which that given feature occurred and also a “global” count of the number of occurrences of the feature in the entire set of input documents. In some implementations, folding information into the forward index includes iterating over each scoring n-gram entry in the forward index, obtaining the respective per-feature quantities (i.e., the global count of that feature) from the inverted index, and annotating the corresponding scoring n-gram in an updated forward index with the obtained per-feature quantity. In some implementations, annotation can include storing the obtained per-feature quantities with the corresponding entry in the forward index.

In stage 320, a score is computed for each pair of candidate documents based on the information contained in the forward index. In some implementations, each pair of candidate documents is assigned a score based on how many common features from the forward index are shared by the candidate documents in the pair, with a higher score being assigned to pairs of candidate documents that share a greater number of features from the forward index. In the present example, the forward index entry of each candidate document in the pair is accessed to obtain the respective scoring n-gram.

Various techniques can be used to score the pairs of candidate documents. In some implementations, the pairs of candidate documents can be scored based on a cosine similarity between the documents. For example, to score a pair of candidate documents d and d′ from the inverted index, the forward index is queried for the entries for both candidate documents. Let F_{d}={f₁, f₂, . . . fₙ} and F_{d′}={f₁′, f₂′, . . . f_{n′}′} be the sets of scoring n-grams in the forward index entries of d and d′, respectively. Let idf(f)=log |D|/df(f) be the inverse document frequency of a scoring n-gram f, where |D| is the number of documents in the input collection of documents 306 and df(f) is the number of documents from which we extracted the feature f Interpreting F_{d} and F_{d′} as incidence vectors in the vector space of n-grams and replacing each non-zero component f with idf(f), the score of the document pair can be computed as the inverse document frequency weighted cosine similarity of F_{d} and F_{d′}.

score(d, d)=(F_{d}·F_{d})/(∥F_{d}∥·∥F_{d′}∥). (1)

In some implementations, pairs of candidate documents having a score below a specified threshold can be discarded to further narrow the list of documents identified as potential translations of one another.

By limiting the frequency of matching n-grams in stage 310, the complexity of the tool can become linear. Let the tunable parameter c be the maximum occurrence count for matching n-grams to be kept in the inverted index. Let m be the average number of matching n-grams extracted from a single document whose count is below c, and D be the set of documents in the input collection of documents (or collection of translated documents). Then the tool can generate up to approximately |D|·m·c candidate pairings. Scoring a given candidate document pair according to the cosine similarity involves computing three dot-products between sparse vectors with one non-zero component per scoring n-gram extracted and not filtered from the respective document. Let s be the average number of such scoring n-grams per document, which is bounded by the average document length. Then the time complexity of the entire document alignment is on the order of approximately (|D|·m·c·s) and therefore linear in the number of input documents and the average document size. In general, the space complexity is dominated by the size of the inverted index and the forward index, both of which are linear in the size of the collection of input documents (or collection of translated documents).

In some implementations, an additional filter can be applied to the pairs of candidate documents to remove document pairs for which the relative ordering of the common features (e.g., scoring n-grams) in each candidate document is significantly different. For example, in some cases, a scoring n-gram may be present in each candidate document of an identified pair, but occur at the beginning of the first candidate document and at the end of the second candidate document. Accordingly, the relative position of each common feature (e.g., scoring n-gram) in the forward index can be extracted from the candidate documents and stored in the forward index. The distance between the two sequences of overlapping features sorted by the n-grams' positions in the respective candidate documents can then be computed. In an example, the distance may be calculated as a normalized permutation edit distance between the features (see “Permutation editing and matching via embeddings” (Cormode et al., Proceedings of the 28th International Colloquium on Automata, Languages and Programming, pp. 481-492, London, UK. Springer-Verlag. 2001). If the distance exceeds a specified threshold, the pair of candidate documents can be discarded.

In some implementations, based on the score obtained in stage 320, one m-best list per language is generated for each candidate document in stage 322, where m is the number of documents in the list. For example, if pairs of candidate documents AB, AD and AG each obtain a score above a specified threshold, where candidate documents B and D, but not G, have been translated from the same source language, then the list identifying the most likely possible translations of document A from the source language corresponds to [B, D]. In stage 326, the remaining candidate pairs are identified as translation pairs(the original language document (e.g., the original source document from the untranslated collection) associated with a first candidate document in the pair is identified as a translation of the original language document associated with the second candidate document in the pair). In some implementations, a join of the identified translation pairs with the original text can then performed by making another pass over the original, untranslated document collection, where the contents of the document pairs with sufficiently high scores then are aggregated. The joined document pairs can be stored in memory, in a database, or output from the tool. Document pairings involving each language used in the source document collection can be identified simultaneously.

Optionally, in some implementations, the candidate pairs are further narrowed in stage 324, where pairs of candidate documents are retained if each document in the pair is also located in the corresponding m-best list for the other document in the pair. If a candidate document is not found in the m-best list for the other document in the pair, then the pair is discarded. For example, a pair of candidate documents AB is identified as a translation pair if the candidate document A can be found in the m-best list for candidate document B and if the candidate document B can be found in the m-best list for candidate document A.

Further filtering can optionally be performed in stage 328 on, for example, a per-sentence basis during sentence alignment of the mined text of the document pairs. In some implementations, the alignment can be performed with a standard dynamic programming sentence alignment algorithm using sentence length and multilingual probabilistic dictionaries as features. Subsequently, words can be aligned within each pair of aligned source (from a first candidate document prior to translation) and target sentences (from a second candidate document prior to translation). This alignment can be used to filter nonparallel sentences. Let S be the set of source words, T the set of target words and S×T the set of ordered pairs. Let the source sentence contain words S₀⊂S and the target sentence contain words T₀⊂T. An alignment A₀⊂S₀×T₀ will be scored by the summation over (s, t)∈A₀ with

score(A₀)=Σln[p(s, t)/(p(s)*p(t))] (2)

where the joint probabilities p(s, t) and marginal probabilities p(s), p(t) are taken to be the respective empirical distributions (without smoothing) in an existing word aligned corpus. This is greedily maximized and the result is divided by its approximate expected value over (s, t) ∈S0×T

Σp(s, t)/p(s)ln[p(s, t)/(p(s)*p(t))] (3)

Sentence pairs, in which the ratio between the actual and the expected score is less than a specified value, such as ⅓, can be discarded. Similarly, sentence pairs, in which a sentence in a first language is identical to a sentence in a second language, or a language detector declares them to be in the wrong language, also can be discarded.

### Applications

An example of an application that can use the techniques described in this disclosure includes training statistical machine translation tools. In training a machine translation tool, the identified translation pairs obtained using the techniques described with respect to FIG. 2 or 3 can be used as templates for defining or refining a translation lexicon of a machine translation tool. For example, a first document in an identified translation pair can be aligned sentence by sentence with a corresponding second document in the identified translation pair, where the first document is in a first language and the second document is in a second different language. Although sentence by sentence alignment is used, other alignment arrangements are possible as well. The resulting alignment provides a data structure that represents a word-for-word connection between the first document and the second document. The alignment then can be used to identify terms or phrases in the first language that correspond to translations of terms or phrases in the second language and vice versa. In some implementations, the identification of corresponding translations can be used to build a translation lexicon for the machine translation tool. Alternatively, or in addition, the identification of the corresponding translations can be used to refine an already existing translation lexicon for the machine translation tool.

In some implementations, the identified translation pairs can be used to perform other natural language processing tasks including, for example, morphological analysis. In morphological analysis, the structure of morphemes and other units of meaning in a language like words, affixes, and parts of speech, are identified and described. Parallel document mining can be used to identify unknown morphemes in a document provided in a first language based on both known morphemes and the context of a parallel aligned document provided in a second different language.

In some implementations, the identified translation pairs obtained through parallel document mining can be used to perform named entity recognition. In named entity recognition, names which are recognized in one language may not be recognized in a second different language. Accordingly, by analyzing document pairs which represent parallel aligned translations, it is possible to equate words or phrases in the second language with the recognized name of the first language. Other applications of parallel document mining include, for example, automatic parsing of natural language.

Although the examples described above pertain to identification of translated document pairs, other applications of the subject matter of the present disclosure are also possible. For example, in some embodiments, the techniques described herein can be used for training automatic speech recognition tools. That is, voice audio recordings and voice audio recording transcriptions are mined to identify audio recording-transcription pairs, where each recording-transcription pair includes a voice audio recording and a respective transcription of the voice audio recording. One or more transcriptions in a collection of transcriptions can be obtained using any suitable speech-to-text engine employed by the tool. As with translation identification, identifying audio recording-transcription pairs can include identifying a group of candidate transcriptions from a collection of transcriptions, where each of the candidate transcriptions shares one or more “rare” features (e.g., tokens), evaluating candidate voice recording-transcriptions pairs based on common features shared by the pairs, scoring the candidate voice recording-transcription pairs based on the evaluation, and determining whether a voice recording-transcription pair is a voice recording and its corresponding transcription if the score associated with the pair is above a pre-defined threshold. The pairs identified as a match (i.e., having a score above the threshold) then can be used as input data for training automatic speech recognition tools.

In another example, the techniques described herein can be used for training optical character recognition (OCR) tools. That is, scanned images of text are paired with their respective machine-readable (MR) text. Identifying scanned image-MR text can include identifying a group of candidate MR text from a collection of MR text, where each of the MR text documents shares one or more “rare” features (e.g., tokens), evaluating candidate scanned image-MR text pairs based on common features shared by the pairs, scoring the candidate scanned image-MR text pairs based on the evaluation, and determining whether a scanned image-MR text pair corresponds to a scanned image and its corresponding MR text if the score associated with the pair is above a pre-defined threshold. The pairs identified as a match (i.e., having a score above the threshold) then can be used as input data for training OCR tools.

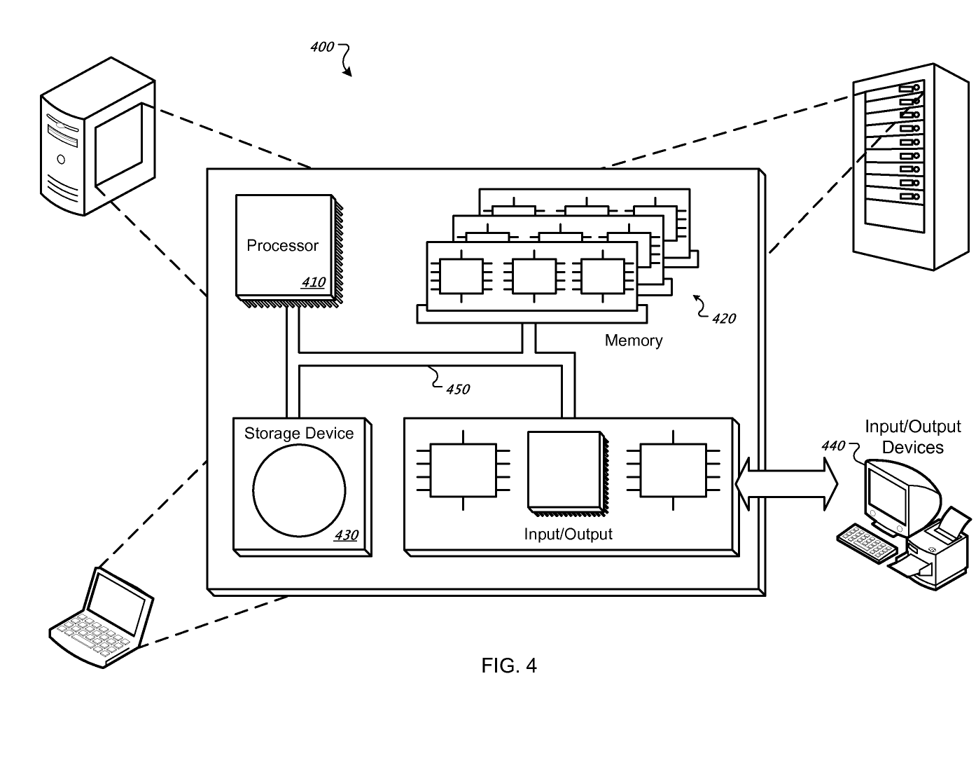

FIG. 4 is a schematic diagram of an example computer apparatus 400 that can be used for executing the operations and techniques described in this specification including, but not limited to, the techniques 200 and 300 of FIGS. 2 and 3, respectively. The apparatus 400 can include a processor 410, a memory 420, a storage device 430, and input/output devices 440. Each of the components 410, 420, 430, and 440 are interconnected using a system bus 450. The processor 410 is capable of processing instructions for execution within the apparatus 400. In some implementations, the processor 410 includes a single-threaded processor. In some implementations, the processor 410 includes a multi-threaded processor. The processor 410 may be capable of processing instructions stored in the memory 420 or on the storage device 430 to display graphical information for a user interface on the input/output device 440.

The memory 420 includes a computer readable medium such as volatile or non volatile memory that stores information within the apparatus 400. The storage device 430 may be capable of providing persistent storage for the apparatus 400. The storage device 430 may be a floppy disk device, a hard disk device, an optical disk device, or a tape device, or other suitable persistent storage means. The input/output device 440 provides input/output operations for the apparatus 400. In one implementation, the input/output device 440 includes a keyboard and/or pointing device. In another implementation, the input/output device 440 includes a display unit for displaying graphical user interfaces.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management tool, an operating system, or a combination of one or more of them.

A computer program (also known as a program, software, software application, script, or code) can be written in any form of programming language, including compiled or interpreted languages, and the computer program can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing apparatus that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the apparatus can be interconnected by any form or medium of digital data communication, e.g., a communication network. Examples of communication networks include a local area network (“LAN”) and a wide area network (“WAN”), e.g., the Internet.

The computing apparatus can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosed subject matter or of what may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various apparatus components in the embodiments described above should not be understood as requiring such separation in all embodiments, and it should be understood that the described program components and apparatuses can generally be integrated together in a single software product or packaged into multiple software products.

A number of implementations and embodiments have been described. Nevertheless, it will be understood that various modifications may be made without departing from the spirit and scope of the disclosed subject matter. Other embodiments also are within the scope of the following claims.

What is claimed is:

1. A computer-implemented method comprising:
extracting, using one or more processors, a plurality of matching features and a plurality of scoring features from a collection of documents in multiple languages;
generating a forward index based on the plurality of scoring features, the forward index comprising one or more scoring feature lists containing at least one scoring feature extracted from the documents in the collection;
generating an inverted index based on the plurality of matching features, the inverted index comprising one or more matching document lists, where each matching document list identifies a group of matching documents from the collection that share a corresponding matching feature;
generating, for each matching document list in the inverted index, a corresponding plurality of matching document pairs;
calculating, for each matching document pair, a score based on information from the forward index; and
determining, based on the score of each matching document pair, whether each matching document pair contains a first matching document and a second matching document that is a translation of the first matching document.

2. The method of claim 1, where the matching features occur less frequently in the collection of documents than the scoring features.

3. The method of claim 1, further comprising translating the collection of documents in multiple languages into a collection of documents in a single language.

4. The method of claim 1, where each one or more scoring feature list is indexed by a different corresponding document in the collection.

5. The method of claim 1, where each matching document list is indexed by the corresponding matching feature.

6. The method of claim 1, where calculating the score based on information from the forward index comprises calculating a cosine similarity between a first scoring feature list corresponding to a first matching document in the matching document pair and a second scoring feature list corresponding to a second matching document in the matching document pair.

7. A method comprising:
providing a collection of documents in multiple languages;
identifying, from the collection of documents, a group of candidate documents, where each candidate document in the group shares a plurality of corresponding rare features having a low frequency of occurrence in the collection of documents;
evaluating, using one or more processors, pairs of candidate documents in the group using a plurality of common features present in the collection of documents, the common features having a frequency of occurrence in the collection of documents that is higher than the rare features; and
determining, based on evaluating the pairs of candidate documents, whether each pair of candidate documents corresponds to a translated pair of documents.

8. The method of claim 1, where providing the collection of documents in multiple languages comprises translating one or more of the documents into a single language.

9. The method of claim 1, where each rare feature is a feature likely to occur in at least one translated document and at least one other document in the collection of documents.

10. The method of claim 9, where each common feature is a feature that is more likely to occur in the collection of documents than any one of the rare features in the collection of documents.

11. The method of claim 1, where the plurality of corresponding rare features or the plurality of common features comprises portions of text extracted from the collection of documents.

12. The method of claim 1, where the plurality of corresponding rare features or the plurality of common features comprises a plurality of n-grams.

13. The method of claim 1, where evaluating the pairs of candidate documents includes scoring each pair of candidate documents based on at least some of the multiple common features to obtain a candidate pair score, and where determining whether each pair of candidate documents corresponds to a translated pair of documents includes discarding one or more pairs of candidate documents having a candidate pair score below a threshold value.

14. A system comprising:
one or more processors and memory operable to interact to perform operations including:
providing a collection of documents in multiple languages;
identifying, from the collection of documents, a group of candidate documents, where each candidate document in the group shares a plurality of corresponding rare features having a low frequency of occurrence in the collection of documents;
evaluating pairs of candidate documents in the group using a plurality of common features present in the collection of documents, the common features having a frequency of occurrence in the collection of documents that is higher than the rare features; and
determining, based on evaluating the pairs of candidate documents, whether each pair of candidate documents corresponds to a translated pair of documents.

15. The system of claim 14, where providing the collection of documents further comprises translating one or more of the documents in multiple languages into a single language.

16. The system of claim 14, where each rare feature is a feature likely to occur in at least one translated document and at least one other document in the collection of documents.

17. The method of claim 16, where each common feature is a feature that is more likely to occur in the collection of documents than any one of the rare features in the collection of documents.

18. The system of claim 14, where the plurality of corresponding rare features or the plurality of common features comprises portions of text extracted from the collection of documents.

19. The system of claim 14, where the plurality of corresponding rare features or the plurality of common features comprises a plurality of n-grams.

20. The system of claim 14, where evaluating the pairs of candidate documents comprises scoring each pair of candidate documents based on at least some of the common features to obtain a candidate pair score, and where determining whether each pair of candidate documents corresponds to a translated pair of documents includes discarding one or more pairs of candidate documents having a candidate pair score below a threshold value.
